(19) United States
(12) Patent Application Publication
(10) Pub. No.: US 2014/0193472 A1
(43) Pub. Date: Jul. 10, 2014

(54) Formulations for paddy rice fields

(71) Applicants: Christian Sowa, Neustadt (DE); Gerhard Peter Dohmen, Weinheim (DE); Martin Obermann, Romerberg (DE); Nadine Riediger, Schifferstadt (DE); Kristin Klappach, Neustadt (DE); Manuel Schmitt, Herschweiler-Pettersheim (DE); Reinhard Stierl, Pune (IN)

(72) Inventors: Christian Sowa, Neustadt (DE); Gerhard Peter Dohmen, Weinheim (DE); Martin Obermann, Romerberg (DE); Nadine Riediger, Schifferstadt (DE); Kristin Klappach, Neustadt (DE); Manuel Schmitt, Herschweiler-Pettersheim (DE); Reinhard Stierl, Pune (IN)

(73) Assignee: BASF SE, Ludwigshafen (DE)

(21) Appl. No.: 14/239,220

(22) PCT Filed: Aug. 16, 2012
(86) PCT No.: PCT/EP2012/065978

§ 371 Date: Feb. 17, 2014

(30) Foreign Application Priority Data
Aug. 19, 2011 (EP) 11178120.9

(51) Int. Cl. A01N 25/28; A01N 43/56

(52) U.S. Cl. CPC A01N 25/28; A01N 43/56
USPC 424/408; 514/407; 514/406

(57) ABSTRACT

The present invention relates to microcapsules, formulations comprising such microcapsules and to methods of combating phytopathogenic pests in paddy rice fields based on such microcapsules.

The present invention relates to microcapsules, formulations comprising such microcapsules and to methods of combating phytopathogenic pests in paddy rice fields based on such microcapsules, wherein
(i) the capsule has a core-shell structure; and
(ii) at least 80% of the pesticide is dissolved in an organic solvent at 25° C. in the core; and
(iii) the capsule shell is based on a polyurethane comprising polyfunctional isocyanate and a polyamine in polymerized form; and
(iv) the ratio by weight of capsule shell in relation to the weight of the capsule is from 1-20%-by weight.

One main objective in paddy rice pesticidal treatment is to achieve targeted release of the pesticidal agent of applied formulations combined with quick adhesion to respective plants to avoid the unwanted release of the pesticidal agent into the environment. The latter may constitute a huge problem because of environmental safety on the one hand and the loss of protection by the pesticidal agent against soil born fungi and insects resulting in strong need in the art to provide tailor-made formulations fulfilling these objectives.

Thus, it is an objective of the present invention to provide a formulation for treatment of paddy rice fields, which provides quick activity of the pesticidal agent on plants to be protected, whereby preventing significant release into the environment (the water or the soil).

This is especially important in view of the fact that many pesticides can have unwanted side effects on aquatic organisms if certain concentrations of the substance in water are exceeded. Thus, while the pesticide contact to the plant and respective pest (e.g. harmful fungi, harmful insect) needs to be established in sufficient concentrations to enable effective pest control, it will be of great environmental benefit to reduce at the same time the concomittant release of pesticide into the water.

Another object underlying the present invention is the desire for formulation that improve plants, a process which is commonly and hereinafter referred to as “plant health”, in particular rice plants.

The term plant health comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), tillering increase, increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination.

The object was solved by the provision of microcapsules wherein
(i) the capsule has a core-shell structure; and
(ii) at least 80% of the pesticide is dissolved in an organic solvent at 25° C. in the core; and
(iii) the capsule shell is based on a polyurethane comprising polyfunctional isocyanate and a polyamine in polymerized form; and
(iv) the ratio by weight of capsule shell in relation to the weight of the capsule is from 1-20%-by weight.

Preferably, the ratio by weight of the pesticide in relation to the total weight of the capsule is from 5-50% by weight, preferably from 8-45 wt % more preferably from 25-35% by weight.

As stated above, at least 80 wt %, preferably at least 90 wt % of the pesticide in the core is dissolved in the organic solvent(s) at 25° C.

The term “pesticide” refers to at least one pesticide selected from the group of fungicides and insecticides. Also mixtures of pesticides from two or more of the aforementioned classes may be used. An expert is familiar with such pesticides, which might be found in the Pesticide Manual, 14th Ed. (2006), The British Crop Protection Council, London or e-Pesticide Manual V5.1, ISBN 978 1 901396 84 3 among other publications.

Suitable fungicides are

A) Respiration inhibitors
Inhibitors of complex III at Qₒ site: the strobilurines azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methylacetamide; and pyribencarb, triclopyricarb/chlorodincarb, famoxadone, fenamidone;
inhibitors of complex III at Qᵢ site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl]2-methylpropanoate, [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl]2-methylpropanoate;
inhibitors of complex II (e.g. carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide;
other respiration inhibitors (e.g. complex I, uncouplers): diflumetorim, (5,8-difluoroquinazolin-4-yl)-{2-[2-fluoro-4-(4-trifluoromethylpyridin-2-yloxy)-phenyl]ethyl}-amine; nitrophenyl derivates: binapacryl, dinobuton, dinocap, fluazinam; ferimzone; organometal compounds: ametoctradin; and silthiofam;
   B) Sterol biosynthesis inhibitors (SBI fungicides)
C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole; imidazoles: imazalil, pefurazoate, prochloraz, triflumizol; pyrimidines, pyridines and piperazines: fenarimol, nuarimol, pyrifenox, triforine;
Delta14-reductase inhibitors: aldimorph, dodemorph, dodemorph-acetate, fenpropimorph, tridemorph, fenpropidin, piperalin, spiroxamine;
Inhibitors of 3-keto reductase: fenhexamid;
   C) Nucleic acid synthesis inhibitors
phenylamides or acyl amino acid fungicides: benalaxyl, benalaxyl-M, kiralaxyl, metalaxyl, metalaxyl-M (mefenoxam), ofurace, oxadixyl;
others: hymexazole, octhilinone, oxolinic acid, bupirimate, 5-fluorocytosine, 5-fluoro-2-(p-tolylmethoxy)pyrimidin-4-amine, 5-fluoro-2-(4-fluorophenylmethoxy)pyrimidin-4-amine;
   D) Inhibitors of cell division and cytoskeleton
tubulin inhibitors, such as benzimidazoles, thiophanates: benomyl, carbendazim, fuberidazole, thiabendazole, thiophanate-methyl; triazolopyrimidines: 5-chloro-7-(4-methylpiperidin-1-yl)-6-(2,4,6-trifluorophenyl)-[1,2,4]triazolo[1,5-a]pyrimidine
other cell division inhibitors: diethofencarb, ethaboxam, pencycuron, fluopicolide, zoxamide, metrafenone, pyriofenone;
   E) Inhibitors of amino acid and protein synthesis
methionine synthesis inhibitors (anilino-pyrimidines): cyprodinil, mepanipyrim, pyrimethanil;
protein synthesis inhibitors: blasticidin-S, kasugamycin, kasugamycin hydrochloride-hydrate, mildiomycin, streptomycin, oxytetracyclin, polyoxine, validamycin A;
   F) Signal transduction inhibitors
MAP/histidine kinase inhibitors: fluoroimid, iprodione, procymidone, vinclozolin, fenpiclonil, fludioxonil;
G protein inhibitors: quinoxyfen;
   G) Lipid and membrane synthesis inhibitors
Phospholipid biosynthesis inhibitors: edifenphos, iprobenfos, pyrazophos, isoprothiolane;
lipid peroxidation: dicloran, quintozene, tecnazene, tolclofos-methyl, biphenyl, chloroneb, etridiazole;
phospholipid biosynthesis and cell wall deposition: dimethomorph, flumorph, mandipropamid, pyrimorph, benthiavalicarb, iprovalicarb, valifenalate and N-(1-(1-(4-cyano-phenyl)-ethanesulfonyl)-but-2-yl) carbamic acid-(4-fluorophenyl) ester;
compounds affecting cell membrane permeability and fatty acids: propamocarb, propamocarb-hydrochlorid
   H) Inhibitors with Multi Site Action
inorganic active substances;
organochlorine compounds (e.g. phthalimides, sulfamides, chloronitriles): anilazine, dichlofluanid, dichlorophen, flusulfamide, hexachlorobenzene, pentachlorphenole and its salts, phthalide, tolylfluanid, N-(4-chloro-2-nitro-phenyl)-N-ethyl-4-methyl-benzenesulfonamide;
guanidines and others: guanidine, dodine, guazatine, guazatine-acetate, iminoctadine, iminoctadine-triacetate, iminoctadine-tris(albesilate);
   I) Cell wall synthesis inhibitors
inhibitors of glucan synthesis: validamycin, polyoxin B; melanin synthesis inhibitors: pyroquilon, tricyclazole, carpropamid, dicyclomet, fenoxanil;
   J) Plant defence inducers
acibenzolar-S-methyl, probenazole, isotianil, tiadinil, prohexadione-calcium; phosphonates: K) Unknown mode of action
chinomethionat, cyflufenamid, cymoxanil, debacarb, diclomezine, difenzoquat, difenzoquat-methylsulfate, fenpyrazamine, flumetover, flusulfamide, flutianil, methasulfocarb, nitrapyrin, nitrothal-isopropyl, proquinazid, tebufloquin, tecloftalam, triazoxide, 2-butoxy-6-iodo-3-propylchromen-4-one, N-(cyclopropylmethoxyimino-(6-difluoro-methoxy-2,3-difluorophenyl)-methyl)-2-phenyl acetamide, N′-(4-(4-chloro-3-trifluoromethyl-phenoxy)-2,5-dimethylphenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, methoxy-acetic acid 6-tert-butyl-8-fluoro-2,3-dimethyl-quinolin-4-yl ester, N-Methyl-2-{1-[(5-methyl-3-trifluoromethyl-1H-pyrazol-1-yl)-acetyl]-piperidin-4-yl}-N-[(1R)-1,2,3,4-tetrahydronaphthalen-1-yl]-4-thiazolecarboxamide, 3-[5-(4-methylphenyl)-2,3-dimethyl-isoxazolidin-3-yl]pyridine, 3-[5-(4-chloro-phenyl)-2,3-dimethyl-isoxazolidin-3-yl]-pyridine (pyrisoxazole), N-(6-methoxy-pyridin-3-yl)cyclopropanecarboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide; L);

### Suitable Insecticides are

organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methylparathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alphacypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin, flucythirnate;
insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
nicotinic receptor agonists/antagonists compounds: clothianidin, dinotefuran, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane;
GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioic acid amide;
macrocyclic lactone insecticides: abamectin, emamectin, milbemectin, lepimectin, spinosad, spinetoram;
mitochondrial electron transport inhibitor (METI) I acaricides: fenazaquin, pyridaben, tebufenpyrad, tolfenpyrad, flufenerim;
METI II and III compounds: acequinocyl, fluacyprim, hydramethylnon;
Uncouplers: chlorfenapyr;
oxidative phosphorylation inhibitors: cyhexatin, diafenthiuron, fenbutatin oxide, propargite;
moulting disruptor compounds: cryomazine;
mixed function oxidase inhibitors: piperonyl butoxide;
sodium channel blockers: indoxacarb, metaflumizone;
others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluoron, and pyrifluquinazon.

The encapsulated pesticide comprises at least one of the aforementioned pesticides, which is one or more fungicides and/or one more insecticides or mixtures of one or more fungicides and/or one more insecticides.

Preferred insecticides are pyrethroids, preferably allethrin, bifenthrin, cyfluthrin, cyhalothrin, cypermethrin, alpha-cypermethrin, beta-cypermethrin, zeta-cypermethrin, deltamethrin, esfenvalerate, fenpropathrin, fenvalerate, imiprothrin, lambda-cyhalothrin, permethrin, prallethrin, pyrethrin I and II, resmethrin, tau-fluvalinate, tefluthrin, tetramethrin, tralomethrin, transfluthrin, profluthrin, dimefluthrin and flucythrinate. The preferred pyrethroid is flucythirnate.

Equally preferred insecticides are nicotinic receptor agonists/antagonists compounds, wherein imidacloprid, acetamiprid, thiacloprid, nitenpyram, clothianidin, thiamethoxam and dinotefuran are preferred.

Equally preferred insecticides are insect growth regulators, wherein diflubenzuron, teflubenzuron, chlorfluazuron, flufenoxuron, hexaflumuron, triflumuron, lufenuron are preferred, and teflubenzuron and flufenoxuron are more preferred.

Equally preferred insecticides are macrocyclic lactone insecticides, wherein lepimectin, emamectin benzoate, abamectin, milbamectin are preferred.

A further, equally preferred insecticide is chlorfenapyr.

A further, equally preferred insecticide is metaflumizone.

A further, equally preferred insecticide is fipronil.

A further, equally preferred insecticide is rynaxypyr (chloranthraniliprole).

More preferred insecticides are the nicotinic receptor agonists/antagonists compounds, wherein imidacloprid, acetamiprid, thiacloprid, nitenpyram, clothianidin, thiamethoxam and dinotefuran are preferred.

Equally more preferred insecticides are insect growth regulators, wherein diflubenzuron, teflubenzuron, chlorfluazuron, flufenoxuron, hexaflumuron, triflumuron, lufenuron are preferred, and teflubenzuron and flufenoxuron are more preferred.

Equally more preferred insecticides are macrocyclic lactone insecticides, wherein lepimectin, emamectin benzoate, abamectin, milbamectin are preferred.

A further, equally more preferred insecticide is chlorfenapyr.

A further, equally more preferred insecticide is metaflumizone.

A further, equally more preferred insecticide is fipronil.

A further, more equally preferred insecticide is rynaxypyr (chloranthraniliprole).

In a preferred embodiment, the encapsulated pesticide comprises one or more fungicides.

Preferably, the encapsulated pesticide comprises one or more pesticides selected from the group of strobilurine fungicides such as azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide, the group of carboxamide fungicide selected from benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide, the group of azoles for example azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole and from the group of various actives such as tricyclazole, isoprothiolane and carpropamid.

In a more preferred embodiment the encapsulated pesticide comprises a strobilurine fungicide, wherein azoxystrobin, coumethoxystrobin, coumoxystrobin, dimoxystrobin, enestroburin, fenaminstrobin, fenoxystrobin/flufenoxystrobin, fluoxastrobin, metominostrobin, orysastrobin, picoxystrobin, pyraclostrobin, pyrametostrobin, pyraoxystrobin, trifloxystrobin are preferred, pyraclostrobin, picoxystrobin, fluxoastrobin are more preferred and pyraclostrobin is most preferred.

In a further more preferred embodiment the encapsulated pesticide comprises a azole fungicide, wherein azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole are preferred, epoxiconazole, prothioconazole, difenoconazole and propiconazole are more preferred, epoxiconazole, prothioconazole, difenoconazole, propiconazole are most preferred and epoxiconazole is utmost preferred.

In a further more preferred embodiment the encapsulated pesticide comprises carboxamide fungicide, wherein bixafen, fluxapyroxad, isopyrazam, penflufen, penthiopyrad, sedaxane, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide and N-[9-(dichloromethylene)-1,2,3,4-tetrahydro-1,4-methanonaphthalen-5-yl]-3-(difluoromethyl)-1-methyl-1H-pyrazole-4-carboxamide are preferred, bixafen, fluxapyroxad, isopyrazam, penflufen, penthiopyrad and sedaxane are more preferred and fluxapyroxad is most preferred.

In a further more preferred embodiment the encapsulated pesticide comprises tricyclazole, isoprothiolane, fenoxanil, dicyclomet, kasugamycin or carpropamid, more preferably tricyclazole tricyclazole or isoprothiolane.

Most preferred encapsulated pesticide are pyraclostrobin or fluxapyroxad, wherein pyraclostrobin is most preferred.

As stated above, also mixtures of pesticides can be encapsulated. Preferred are mixtures of pyraclostrobin and at least one of the aforementioned pesticides.

Most preferred mixtures are the following binary mixtures set forth in Table 1.

TABLE 1

| No | Compound I | Compound II |
|---|---|---|
| M-1. | pyraclostrobin | fluxapyroxad |
| M-2. | pyraclostrobin | tricyclazole |
| M-3. | pyraclostrobin | isoprothiolane |
| M-4. | pyraclostrobin | carpropamid |
| M-5. | pyraclostrobin | epoxiconazole |
| M-6. | pyraclostrobin | fenoxanil |
| M-7. | pyraclostrobin | diclocymet |
| M-8. | pyraclostrobin | kasugamycin |

The mixtures of table I usually comprise the active in weight ratio of compound I to component II of from 500:1 to 1:500, preferably from 100:1 to 1:100, more preferably from 50:1 to 1:50, even more preferably from 20:1 to 1:20, particularly preferably from 10:1 to 1:10, in particular from 5:1 to 1:5.

In an utmost preferred embodiment, the encapsulated pesticide(s) is pyraclostrobin, fluxapyroxad and the mixtures M-1, M-2, M3 and M4, wherein in this subset, pyraclostrobin, fluxapyroxad and the mixtures M-1, M-2 are preferred, and pyraclostrobin, fluxapyroxad and the mixtures M-1 are more preferred and pyraclostrobin is most preferred.

The encapsulated pesticide is comprised in the formulation from 1 to 40%, preferable 2 to 25%, even more preferably from 8 to 15%. If a mixture of encapsulated and other non-encapsulated active ingredients are present in the formulation, then the formulation will contain from 1 to 30% encapsulated and 1 to 30% non-encapsulated active ingredients, preferably 2 to 15% encapsulated and 2 to 25% non-encapsulated active ingredients and even more preferably 5 to 15% encapsulated and 5 to 20% non-encapsulated active ingredients.

The average particle size of the capsules (z-average by means of light scattering; preferably a D[4,3] average) is 0.5 to 50 μm, preferably 0.5 to 10 μm, more preferably 2 to 10 μm, and especially 5 to 10 μm, utmost preferably 6 to 10 μm.

The particle size of the microcapsule dispersion was determined using a Malvern Particle Sizer model 3600E or a Malvern Mastersizer 2000 in accordance with a standard measuring method which is documented in the literature. The D[v, 0.1] value means that 10% of the particles have a particle size (in accordance with the volume average) up to this value. Accordingly, D[v, 0.5] means that 50% of the particles and D[v, 0.9] means that 90% of the particles have a particle size (according to the volume average) less than/equal to this value. The span value arises from the quotient from the difference D[v, 0.9]−D[v, 0.1] and D[v, 0.5]. The D[4.3] value is the weight-average.

The solvent of the capsule core comprises at least one non-polar solvent, by definition meaning one or more non-polar solvents, mixtures of one or more non-polar solvents with polar solvents. A polar solvent is a solvent, which has at 25° C. a solubility in water of at least 5% by weight. A non-polar solvent is a solvent, which has at 25° C. a solubility in water of less than 5% by weight.

Suitable non-polar solvents are C₈ to C₁₁ aromatic petroleum derivatives (aromatichydrocarbons) with a solubility in water at room temperature of <0.1% (w/w) and a distillation range from 130° C. to 300° C. (commercially available from ExxonMobil or BP under the following brand names: Solvesso® 100, Solvesso® 150, Solvesso® 200, 30 Solvesso® 150ND, Solvesso® 200ND, Aromatic® 150, Aromatic® 200, Hydrosol® A 200, Hydrosol® A 230/270, Caromax® 20, Caromax® 28, Aromat® K 150, Aromat® K200, Shellsol® A 150, Shellsol® A 100, Fin® FAS-TX 150, Fin® FAS-TX 200), vegetable oils such as coco oil, palm kern oil, palm oil, soya oil, rapeseed oil, corn oil and the methyl or ethyl esters of the afore-mentioned oils, hydrocarbons such as aromatic depleted, linear paraffinic, isoparaffinic, cycloparaffinic having a flash point between 40° C. and 250° C. and a distillation range between 150° C. and 450° C., esters, such as terpenoid esters (for example isobornylacetate), benzylacetate, benzyl benzoate, butyl benzoate, 2-ethoxypropylacetate, methyl proxitol acetate; tributyl phosphate; and amides such as N,N-dialkyl alkylamides, preferably fatty acid dimethylamides, more preferably N,N-dimethyl octanamide and/or N,N-dimethyl decanamide (mixtures are commercially available as Hallcomide® M 8-10 from The P.C. Hall Co., Agnique® KE3658 from Cognis, Genagen® 4166 from Clariant) and n-octyl-2-pyrrolidone (NOP).

Examples of polar solvents are anisole, sulfoxides such as dimethylsulfoxid (DMSO); and lactones such as γ-butyrolactone (GBLO); N-ethyl-2-pyrrolidone (NEP); and N-docedyl pyrrolidone; ketones such as 2-heptanone, cyclohexanone, acetophenone, and acetophenone derivatives such as 4-methoxy acetophenone; and alcohols such as cyclohexanol, benzyl alcohol, diacetone alcohol, for example 4-hydroxy-4-methyl-2-pentanone, n-octanol, 2-ethylhexanol; and diesters such as mixtures of dimethyl glutarate and dimethyl succinate and dimethyl adipate (commercially available Rhodiasolv® RPDE from Rhodia), or mixtures of diisobutyl glutarate and diidobutyl succinate and diisobutyl adipate; and glycol and derivatives such as, propylene glycol monomethyl ether acetate, dipropylene glycol monomethyl ether, propylene glycol monophenyl ether; and alkylene carbonates such as propylene carbonate, butylene carbonate; and pyrrolidones, derivatives such, N-ethyl pyrrolidone, and lactate esters such as n-propyl lactate, methyl lactate, ethyl lactate, isopropyl lactate, butyl lactate, commercially available under the tradenames PURASOLV® NPL, PURASOLV® ML, PURASOLV® EL, PURASOLV® IPL, PURASOLV® BL or mixtures selected from at least two of the aforementioned solvents.

Preferably, the solvent of the capsule core comprises one or more non-polar solvents.

Preferred non-polar solvents are Suitable non-polar solvents are C₈ to C₁₁ aromatic petroleum derivatives (aromatichydrocarbons) with a solubility in water at room temperature of <0.1% (w/w) and a distillation range from 130° C. to 300° C., vegetable oils such as coco oil, palm kern oil, palm oil, soya oil, rapeseed oil, corn oil and the methyl or ethyl esters of the afore-mentioned oils, hydrocarbons such as aromatic depleted, linear paraffinic, isoparaffinic, cycloparaffinic having a flash point between 40° C. and 250° C. and a distillation range between 150° C. and 450° C. and amides such as N,N-dialkyl alkylamides, preferably fatty acid dimethylamides, more preferably N,N-dimethyl octanamide and/or N,N-dimethyl decanamide. Further preferred non-polar solvents are esters of terpenoic acids such as e.g. Isobornylacetate.

More preferred non-polar solvents are C₈ to C₁₁ aromatic petroleum derivatives (aromatichydrocarbons) with a solubility in water at room temperature of <0.1% (w/w) and a distillation range from 130° C. to 300° C., hydrocarbons such as aromatic depleted, linear paraffinic, isoparaffinic, cycloparaffinic having a flash point between 40° C. and 250° C. and a distillation range between 150° C. and 450° C. and amides such as N,N-dialkyl alkylamides, preferably fatty acid dimethylamides, more 15 preferably N,N-dimethyl octanamide and/or N,N-dimethyl decanamide.

The required amount of solvents depends on the nature of the selected solvent and the solubility of the active ingredient or active ingredients intended to be encapsulated therein. For example, a suitable amount of is from 0.1 to 40% w/w, more preferred from 5 to 25% w/w and even more preferred from 8 to 15% w/w. All concentrations of solvent refer to the final formulation, i.e. including the mixes with crystalline further active ingredients.

The ratio by weight of capsule shell in relation to the total weight of the capsule is from 1-25% by weight, preferably from 5-25% by weight, more preferably from 5-20% by weight, most preferably from 10-20% by weight.

The given ratio by weight of capsule shell in relation to the total weight of the capsule corresponds to the wall thickness and corresponds to wall thickness is preferably from 0.07 to 0.5 μm, more preferably from 0.1 to 0.4 μm and even more preferably from 0.13 to 0.35 μm.

The capsule shell is based on a polyurethane comprising polyfunctional isocyanate and a polyamine in polymerized form.

Capsules with encapsulation material comprising such polyurethanes are well known and can be prepared by analogy to prior art. They are preferably prepared by an interfacial polymerization process of a suitable polymer wall forming material. Interfacial polymerization is usually performed in an aqueous water-in-oil emulsion or suspension of the core material containing dissolved therein at least one part of the polymer wall forming material. During the polymerization, the polymer segregates from the core material to the boundary surface between the core material and water thereby forming the wall of the microcapsule. Thereby an aqueous suspension of the microcapsule material is obtained. Suitable methods for interfacial polymerization processes for preparing microcapsules containing pesticide compounds have been disclosed in prior art, e.g. U.S. Pat. No. 3,577,515, U.S. Pat. No. 4,280,833, U.S. Pat. No. 5,049,182, U.S. Pat. No. 5,229,122, U.S. Pat. No. 5,310,721, U.S. Pat. No. 5,705,174, U.S. Pat. No. 5,910,314, WO 95/13698, WO 00/10392, WO 01/68234, WO 03/099005, EP 619,073 or EP 1,109,450, to which full reference is made.

Suitable wall forming materials for polyurethane capsules according to the present invention comprises polyfunctional isocyanate (also called polyisocyanate) and a polyamine in polymerized form.

It is also known, that an isocyanate group may react with water to a carbamic acid group, which in turn may eliminate carbon dioxide to yield finally an amine group.

Thus, in a further embodiment, the 2-component system polyfunctional isocyanate/polyamine may be prepared by reacting the polyfunctional isocyanate with water.

In general, polyurethane is formed by reacting a polyisocyanate, having at least two isocyanate groups with the polyamine having at least two primary amino groups, optionally in the presence of a polyfunctional acid chloride, to form a polyurea wall material. Polyisocyanates may be used individually or as mixtures of two or more Polyisocyanates. Polyisocyanates which are suitable for use include di- and triisocyanates, wherein the isocyanate groups are attached to an aliphatic or cycloaliphatic moiety (aliphatic isocyanates) or to an aromatic moiety (aromatic isocyanates).

Examples of suitable aliphatic diisocyanates include tetramethylene diisocyanate, pentamethylene diisocyanate and hexamethylene diisocyanate as well as cycloaliphatic isocycantates such as isophoronediisocyanate, 1,4-bisisocyanatocyclohexane and bis-(4-isocyanatocyclohexyl)methane.

Suitable aromatic isocyanates include toluene diisocyanates (TDI: a mixture of the 2,4- and 2,6-isomers), diphenylmethene-4,4′-diisocyanate (MDI), polymethylene polyphenyl isocyanate, 2,4,4′-diphenyl ether triisocyanate, 3,3′-dimethyl-4,4′-diphenyl diisocyanate, 3,3′-dimethoxy-4,4′-diphenyl diisocyanate, 1,5-naphthylene diisocyanate and 4,4′,4″-triphenylmethane triisocyanate. Also suitable are higher oligomers of the aforementiende diisocyanates such as the isocyanurates and biurethes of the aforementioned diisocyanates and mixtures thereof with the afore-mentioned diisocyanates.

In a further embodiment, the polyisocyanate is an oligomeric isocyanates. Such oligomeric isocyanates may comprise above mentioned aliphatic diisocyanates and/or aromatic isocyanates in oligomerized form. The oligomeric isocyanates have an average functionality in the range of 2.0 to 4.0, preferably 2.1 to 3.2, an more preferably 2.3 to 3.0. Typically, these oligomeric isocyanates have a viscosity (determined according to DIN 53018) in the range from 20 to 1000 mPas, more preferably from 80 to 500 mPas and especially from 150 to 320 mPas. Such oligomeric isocyanates are commercially available, for example from BASF SE under the tradenames Lupranat® M10, Lupranat® M20, Lupranat® M50, Lupranat® M70, Lupranat® M200, Lupranat® MM103 or aliphatic isocyanates as Basonat® A270 or Basonat HI 100.

Also suitable are adducts of diisocyanates with polyhydric alcohols, such as ethylene glycol, glycerol and trimethylolpropane, obtained by addition, per mole of polyhydric alcohol, of a number of moles of diisocyanate corresponding to the number of hydroxyl groups of the respective alcohol and mixtures thereof with the aforementioned diisocyanates. In this way, several molecules of diisocyanate are linked through urethane groups to the polyhydric alcohol to form high molecular weight polyisocyanates. A particularly suitable product of this kind, DESMODUR® L (Bayer Corp., Pittsburgh), can be prepared by reacting three moles of toluene diisocyanate with one mole of 2-ethylglycerol (1,1-bismethylolpropane). Further suitable products are obtained by addi-tion of hexamethylene diisocyanate or isophorone diisocyanate with ethylene glycol or glycerol.

Preferred polyisocyanates are isophorone diisocyanate, diphenylmethane-4,4′-diisocyanate, toluene diisocyanates. In another embodiment, preferred polyisocyanates are oligomeric isocyanates.

Suitable polyamines within the scope of this invention will be understood as meaning in general those compounds that contain two and more amino groups in the molecule, which amino groups may be linked to aliphatic or aromatic moieties.

Examples of suitable aliphatic polyamines are polyethylenimines of the formula H₂N—(CH₂—CH₂—NH)ₙ—H, wherein n is an integer from 2 to 5. Representative examples of such polyethylenimines are diethylenetriamine, triethylenetetramine, tetraethylenepentamine and pentaethylenehexamine.

Examples of suitable aromatic polyamines are 1,3,5-triaminobenzene, 2,4,6-triaminotoluene, 1,3,6-triaminonaphthalene, 2,4,4′-triaminodiphenyl ether, 3,4,5-triamino-1,2,4-triazole and 1,4,5,8-tetraminoanthraquinone. Those polyamines which are insoluble or insufficiently soluble in water may be used as their hydrochloride salts.

Polyamines, such as those mentioned above may be used individually or as mixtures of two or more polyamines.

Suitable diamines within the scope of this invention will be understood as meaning in general those compounds that contain two amino groups in the molecule, which amino groups may be linked to aliphatic or aromatic moieties.

Examples of suitable aliphatic diamines are α,ω-diamines of the formula H₂N—(CH₂)ₙ—NH₂, wherein n is an integer from 2 to 6.

Examples of suitable aromatic diamines are 1,3-phenylenediamine, 2,4- and 2,6-toluenediamine, 4,4′-diaminodiphenylmethane, 1,5-diaminonaphthalene Those polyamines which are insoluble or insufficiently soluble in water may be used as their hydrochloride salts.

Diamines, such as those mentioned above may be used individually or as mixtures of two or more diamines.

Preferred diamines are aliphatic diamines as defined above, wherein α,ω-diamines of the formula H₂N—(CH₂)ₙ—NH₂, wherein n is an integer from 2 to 6 are preferred, ethylenediamine, propylene-1,3-diamine, tetramethylenediamine, pentamethylenediamine and hexamethylenediamine are more preferred, and hexamethylenediamine is most preferred.

Preferred amines are aliphatic polyamines of the formula H₂N—(CH₂—CH₂—NH)ₙ—H, wherein n is an integer from 2 to 5, preferably diethylenetriamine, triethylenetetramine, tetraethylenepentamine and pen-taethylenehexamine, wherein diethyltriamine is most preferred.

The relative amounts of each complementary wall-forming component will vary with their equivalent weights. In general, approximately stoichiometric amounts are pre-ferred, while an excess of one component may also be employed, especially an excess of polyisocyanate. The total amount of wall-forming components approximately corresponds to the total amount of polymeric wall-forming materials.

The microcapsules according to the present invention may additionally comprise a surfactant, which is dissolved in the solvent of the capsule core.

The ratio by weight of surfactant in relation to the total weight of the capsule is from 1-60% by weight, preferably from 1-50% by weight, more preferably from 15-40, most preferably 25-40% by weight.

Suitable surfactants are non-ionic surfactants. Examples of surfactants are listed in McCutcheon's, Vol. 1: Emulsifiers & Detergents, McCutcheon's Directories, Glen Rock, USA, 2008 (International Ed. Or North American Ed.).

Examples of suitable nonionic surfactants are alkoxylates, alkoxylated N-substituted fatty acid amides, amine oxides, esters, sugar-based surfactants, polymers, block polymers, silicon oils and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymers are homo- or copolymers of vinylpyrrolidone, vinylalcohols, or vinylacetate. Examples of silicon oils are polydimethylsiloxanes and alkoxylated polydimethylsiloxane derivatives, for example Breakthru products from Evonik or Silwet products from O—Si Chemicals. Examples of block polymers are block polymers of the A-B or A-B-A type comprising blocks of polyethylene oxide and polypropylene oxide or of the A-B-C type comprising alkanol, polyethylene oxide and polypropylene oxide.

Preferred nonionic surfactants are alkoxylates and block polymers.

The microcapsules according to the present invention may be further converted in a agrochemical formulation.

The microcapsules are prepared in a known manner, as described above by means of interfacial polymerization, for example by preparation of an organic and an aqueous phase, where the organic phase is a solution of the active ingredient in a suitable solvent together with the required amounts of isocyanate and emulsifiers. This solution is emulsified at a temperature from 5° C. to 30° C., preferably from 15 to 25, most preferably from 18 to 25° C. into the aqueous phase using high shear mixing equipment, e.g. a colloid mill. Depending on a given recipe with its selected emulsifiers at the selected rates, the shear force input by the colloid mill will determine the emulsion droplet size, which is in a narrow range the same as for the capsule size as received after the capsule formation process is completed. Given for a certain recipe, the emulsion droplet size distribution and thus the capsule size distribution can be adjusted in a certain range that depends on the selected recipe, by the preset of rotation speed of the colloid mill, which is equivalent to distinct shear forces in the colloid milk. The obtained emulsion is gently stirred while the weighed amount of amine or an amine solution is slowly added. After addition is completed, the mixture is heated up to a temperature between 40-80° C. for 2-24 hours, after which the curing reaction is completed. Preferred temperatures are 50-70° C., even more preferred is 55-65° C. The completion of the reaction can best be determined using infrared spectroscopy. In the IR, a strong band between 2300 cm-1 to 2250 cm-1 indicates still presence of unreacted isocyanate. As soon as the band has completely disappeared, the reaction is completed and the capsule suspension is cooled down to 20-30° C.

In a particular preferred embodiment, the resulting composition comprising microcapsules comprises

10-500 g/l by weight, preferably from 30-300 g/l, more preferably from 50-250 g/l encapsulated pesticide,
10 to 450 g/l, 50 g-300 g/l preferably, more preferably 80 g-200 g/l organic solvent, 1 to 200 g/l surfactant (nonionic surfactant),
35 to 80 g/l polyisocyanate and 0.5 to 15 g/l polyamine and water up to one liter.

The sum of weights of organic solvent, dissolved active ingredient, optional surfactants that are enclosed in the capsules and capsule wall poly urea (formed by the reaction of isocyanate and amine) in relation to the total weight per liter is sometimes referred to as solid content. This solid content may range from 10 to 60% w/w, more preferably from 15 to 45% w/w, even more preferably from 20 to 35% w/w.

Agrochemical formulation can be prepared by adding suitable auxiliaries to the prepared microcapsules and optionally a further pesticide as described below to finally achieve the desired active ingredient loading. The final formulation contains 2-55% w/w of capsules, preferably 5-50% w/w, even more preferred 15-50% w/w.

Examples for suitable auxiliaries are solvents, liquid carriers, solid carriers or fillers, surfactants (such as dispersants, emulsifiers, wetters, solubilizers, penetration enhancers, protective colloids, adhesion agents, adjuvants), thickeners, humectants, repellents, attractants, compatibilizers, bactericides, anti-freezing agents, anti-foaming agents, colorants, tackifiers, buffers and binders.

Suitable surfactants are surface-active compounds, such as anionic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

The amount of further surfactants (such as dispersants, emulsifiers, wetters, solubilizers, penetration enhancers, protective colloids, adhesion agents) used in the final capsule suspension is from 5-25% w/w, preferably, 5-20% w/w, more preferred from 7-15% w/w.

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide and/or butylene oxide may be employed for the alkoxylation, preferably ethylene oxide. Also Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the pesticide on the target. Examples are surfactants, mineral or vegetable oils, and other auxilaries. Further examples are listed by Knowles, Adjuvants and additives, Agrow Reports DS256, T&F Informa UK, 2006, chapter 5. Preferred surfactants, which may act as adjuvans, are for example non-ionic surfactants such as alkoxylates, N-substituted fatty acid amides, esters, sugar-based surfactants, polymeric surfactants, and mixtures thereof, for examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide and/or butylene oxide may be employed for the alkoxylation, preferably ethylene oxide and/or propylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of ylnylpyrrolidone, vinylalcohols, or vinylacetate. If an adjuvant is present in the formulation, the amount of adjuvant in the formulation is from 3-40% w/w, preferably, 5-20% w/w, even more preferred 8-15% w/w.

Suitable bactericides are bronopol and isothiazolinone derivatives such as alkylisothiazolinones and benzisothiazolinones.

If bactericides is present in the formulation, the amount of biocide in the final formulation ranges from 0.1-1% w/w, preferably from 0.1-0.5% w/w, even more preferred from 0.1-0.3% w/w.

Suitable thickeners are polysaccharides (e.g. xanthan gum, carboxymethylcellulose), anorganic clays (organically modified or unmodified), polycarboxylates, and silicates.

If thickeners are present in the formulation, the amount of thickeners in the final formulation ranges from 0.1-1.5% w/w, preferably from 0.1-1.0% w/w, even more preferred from 0.2-0.5%.

Suitable anti-freezing agents are ethylene glycol, propylene glycol, urea and glycerin. In preferred embodiment, the formulation comprise an anti-freeze. The amount of anti-freeze agent in the final formulation ranges from 2-15% w/w, preferably from 4-10% w/w, even more preferred from 5-10%.

Suitable anti-foaming agents are silicones, long chain alcohols, and salts of fatty acids.

If anti-foaming agents is present in the formulation, the amount of antifoam agents in the final formulation ranges from 0-5% w/w, preferably from 0.1-1% w/w, even more preferred from 0.1-0.5% w/w.

Suitable buffers are phosphate buffers, citric acid based buffers, acetic acid based buffers and other buffer systems based on weak organic or inorganic acids known to those skilled in the art. Please state the ratio by weight of neutralizing agents, buffers to be used in the CS “formulation”

If buffers are present in the formulation, the amount of buffers in the final formulation ranges from 0.1-10% w/w, preferably from 0.1-3% w/w, even more preferred from 0.1-2%.

The amount of further auxiliaries (e.g. humectants, repellents, attractants, compatibilizers, colorants, tackifiers and binders) is, if such auxilaries are present in the final formulation, from 0.1 to 20% w/w.

The formulation as defined in above can optionally also further comprise an additional non-encapsulated pesticide.

The additional pesticide may be selected from the aforementioned pesticides. The non-encapsulated, additional pesticide may be present in a dissolved, suspended and/or emulsified form. Preferably, the non-encapsulated, additional pesticide is present in a dispersed form, preferably in suspended in solid form. Practically, such pesticide can be added either during finishing in form of milled solid particles together with a suitable surfactant or in form of a suitable formulation (e.g. in a conventional suspension concentrate, emulsifiable organic solution or dissolved form. The non-encapsulated, additional pesticide may comprise a fungicide or insecticide.

Preferred non-encapsulated fungicides are azole fungicide, wherein azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole are preferred, epoxiconazole, prothioconazole, difenoconazole and propiconazole are more preferred, epoxiconazole, prothioconazole, difenoconazole, propiconazole are most preferred and epoxiconazole is utmost preferred.

In a further more preferred embodiment the non-encapsulated pesticide comprises carboxamide fungicide, wherein bixafen, fluxapyroxad, isopyrazam, penflufen, penthiopyrad, sedaxane, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide and N-[9-(dichloromethylene)-1,2,3,4-tetrahydro-1,4-methanonaphthalen-5-yl]-3-(difluoromethyl)-1-methyl-1H-pyrazole-4-carboxamide are preferred, bixafen, fluxapyroxad, isopyrazam, penflufen, penthiopyrad and sedaxane are more preferred and fluxapyroxad is most preferred.

In a further more preferred embodiment the non-encapsulated pesticide comprises tricyclazoleisoprothiolane, thiadinil, isothianil or carpropamid, more preferably tricyclazole.

In a further more preferred embodiment the non-encapsulated pesticide comprises kasugamycin, probenazole or diclocymet. Examples of suitable combinations are set forth in Table 2, wherein combinations R-1 to R-:

TABLE 2

| No | Encapsulated Pesticide | non-encapsulated Pesticide |
|---|---|---|
| R-1. | pyraclostrobin | fluxapyroxad |
| R-2. | pyraclostrobin | tricyclazole |
| R-3. | pyraclostrobin | isoprothiolane |
| R-4. | pyraclostrobin | carpropamid |
| R-5. | pyraclostrobin | epoxiconazole |
| R-6. | pyraclostrobin | fenoxanil |
| R-7. | pyraclostrobin | propiconazole |
| R-8. | pyraclostrobin | difenconazole |
| R-9. | pyraclostrobin | isothianil |
| R-10. | pyraclostrobin | kasugamycin |
| R-11. | pyraclostrobin | carpropamid |
| R-12. | pyraclostrobin | probenazole |
| R-13. | pyraclostrobin | diclocymet |
| R-14. | pyraclostrobin | thiadinil |
| R-15. | pyraclostrobin and fluxapyroxad | tricyclazole |
| R-16. | pyraclostrobin and fluxapyroxad | isoprothiolane |
| R-17. | pyraclostrobin and fluxapyroxad | carpropamid |
| R-18. | pyraclostrobin and fluxapyroxad | epoxiconazole |
| R-19. | pyraclostrobin and fluxapyroxad | fenoxanil |
| R-20. | pyraclostrobin and fluxapyroxad | propiconazole |
| R-21. | pyraclostrobin and fluxapyroxad | difenconazole |
| R-22. | pyraclostrobin and fluxapyroxad | isothianil |
| R-23. | pyraclostrobin and fluxapyroxad | kasugamycin |
| R-24. | pyraclostrobin and fluxapyroxad | carpropamid |
| R-25. | pyraclostrobin and fluxapyroxad | probenazole |
| R-26. | pyraclostrobin and fluxapyroxad | thiadinil |
| R-27. | pyraclostrobin and fluxapyroxad | diclocymet |
| R-28. | fluxapyroxad | tricyclazole |
| R-29. | fluxapyroxad | isoprothiolane |
| R-30. | fluxapyroxad | carpropamid |
| R-31. | fluxapyroxad | epoxiconazole |
| R-32. | fluxapyroxad | fenoxanil |
| R-33. | fluxapyroxad | propiconazole |
| R-34. | fluxapyroxad | difenconazole |
| R-35. | fluxapyroxad | isothianil |
| R-36. | fluxapyroxad | kasugamycin |
| R-37. | fluxapyroxad | carpropamid |
| R-38. | fluxapyroxad | probenazole |
| R-39. | fluxapyroxad | diclocymet |
| R-40. | fluxapyroxad | thiadinil |

The CS formulation usually comprises the further non-encapsulated pesticide from 20 g to 400 gill, preferably from 30 g to 250 g/l, more preferably from 40 g to 200 g/l and most preferably from 50 g to 150 g/l.

The invention also relates to a method for increasing the health of plants, in particular rice plants in paddy rice fields comprising the treatment with a formulation as defined above.

The invention further relates to a method of combating phytopathogenic pests in paddy rice fields, comprising the treatment with a formulation as defined above.

Depending on the actives present in the capsule core or also the presence of the non-encapsulated pesticide, the term “pests” relates to phytophathogenic fungi or phytophathogenic insects.

Examples of phytophathogenic fungi in rice are

Alternana species on rice, Bipolaris (e.g. Bipolaris oryzae), and Drechslera species on rice, Cercospora oryzae, Cochliobolus miyabeanus, Curvularia lunata, Sarocladium oryzae, S. attenuatum, Entyloma oryzae, Fusarium spp such as Fusarium semitectum (and/or moniliforme Gibberella fujikuroi (bakanae), Grainstaining complex (various pathogens), and/or Pythium ssp. Helminthosporium. spp, for example Helminthosporium oryzae, Microdochium oryzae, Pyricularia grisea (syn. Pyricularia oryzae), Rhizoctonia species, for example Rhizoctonia solani (syn in rice Pelliculana sasakii), Corticium sasakii and Ustilaginoidea virens.

Examples of phytophathogenic insects in rice are rice water weevil (Lissorhoptrus olyzaphilus), rice stem borer (Chilo suppresalis), rice leaf roller, rice leaf beetle, rice leaf miner (Agromyca oryzae), leafhoppers (Nephotettix spp.; especially smaller brown leafhopper, green rice leafhopper), planthoppers (Delphacidae; especially white backed planthopper, brown rice planthopper), stinkbugs;

In a preferred embodiment method of combating phytopathogenic pests in paddy rice fields, comprising the treatment with CS formulation as defined above, wherein the encapculated pesticide is pyraclostorbin and the phytopathogenic pests are Pyricularia grisea (syn. Pyricularia oryzae) and/or Rhizoctonia species, in particular Rhizoctonia solani (syn in rice Pelliculana sasakii).

In a further preferred embodiment method of combating phytopathogenic pests in paddy rice fields, comprising the treatment with CS formulation as defined above, wherein the encapculated pesticides are pyraclostrobin and fluxapyroxad and the phytopathogenic pests are Pyricularia grisea (syn. Pyricularia oryzae) and/or Rhizoctonia species, in particular Rhizoctonia solani (syn in rice Pelliculana sasakii).

In a further preferred embodiment method of combating phytopathogenic pests in paddy rice fields, comprising the treatment with CS formulation as defined above, wherein the encapculated pesticide is pyraclostrobin, and the further, non-encapsulated pesticide is fluxapyroxad and the phytopathogenic pest are Pyricularia grisea (syn. Pyricularia oryzae) and/or Rhizoctonia species, in particular Rhizoctonia solani (syn in rice Pelliculana sasakii).

In a further preferred embodiment method of combating phytopathogenic pests in paddy rice fields, comprising the treatment with CS formulation as defined above, wherein the encapculated pesticide is pyraclostrobin, and the further, non-encapsulated pesticide is tricylazole and the phytopathogenic pest are Pyricularia grisea (syn. Pyricularia oryzae) and/or Rhizoctonia species, in particular Rhizoctonia solani (syn in rice Pelliculana sasakii).

In the above-referred methods, the amount of pesticide is usually in the range from 10 per 500 g/ha.

For example, for pyraclostrobin, preferred ratios are from 10 to 150 g/ha.

For example, for fluxapyroxad, preferred ratios are from 10 to 120 g/ha

The invention is further illustrated, but not limited by the following examples.

### EXAMPLES

### Example 1

### Preparation of Microcapsules

Solvesso® 200: Aromatic hydrocarbon solvent, destillation range from 238-278° C. (commercially available from Exxon)
Puccini® P 29: Highly refined mineral oil (commercially available from Q8)
Plurafac® LF 1300: Alkoxylated stearyl alcohol (commercially available from BASF SE)
Emulsogen® 3510: Butyldiglycol, polyoxyethylen, polyoxypropylen block co-polymer (commercially available from Clariant)
Tersperse® 2500: A methyl methacrylate graft polymer (reaction product of methyl methacrylate, methacrylic acid and methoxy PEG methacrylate), 33 wt %, propylene glycol and water (commercially available from Huntsman)
Mowiol® 18-88: polyvinyl alcohol from partially hydrolyzed polyvinyl acetate (commercially available from Kuraray)
Borresperse® Na: Sodium lignosulfonic acid (commercially available from Borregaard Lignotech)
Lupranat® M 20 S: solvent free polyisocyanate based on 4,4′-diphenylmethane diisocyanate (MDI) with an average functionality of 2.7; NCO content ca 32 g/100 g (commercially available from BASF Elastogran)
Basonat® HI 100: Hexamethylene-1,6-diisocyanate (commercially available from BASF SE)
DETA: diethylenediamine (commercially available from BASF SE)
HMDA: hexamethylene-1,6-diamine (commercially available from BASF SE), 10% aqu. solution
Atlox® 4912: polyhydroxic acid esterified with polyethylene glycol (commercially available from Croda)
Acticide® MBS: an aqueous solution of methylisothizolinoe (MIT) and benzisothizolinon (BIT) used as biocide (commercially available from Thor)
Silicon SRE-PFL: emulsion of polydimethylsiloxane on silica particles used as antifoam (commercially available from Wacker)
Plurafac LF 711: alcohol alkoxylate (commercially available from BASF SE)
Plurafac LF 801: C8-C10 alcohol alkoxylate (commercially available from BASF SE)
Lutensol® ON 60: alcohol ethoxylate (6 EO) (commercially available from BASF SE)
Genapol® C 100: coconut oil ethoxylate (10 EO) (commercially available from Clariant)
Lutensit® A-BO: solution of sodium dioctylsulfosuccinte in water/propylene glycol (commercially available from BASF SE)
Tween® 20: sorbitan mono oleate ethoxylate (commercially available from Croda)
Empilan® KR 6: C9/11 alcohol ethoxylate (6 EO) (commercially available from Huntsman)
Synergen® GL 5: polyglycerol ester, esterified with phthalic acid and coconut fatty acid (commercially available from Clariant)
Plurafac LF 900: alcohol alkoxylate (commercially available from BASF SE)
Sipernat 22: amorphous, precipitated silica (commercially available from Evonik Industries)

TABLE I
A: Samples 1-5

| | | Sample Number |
|---|---|---|
| | | 1 |
| | Setting at Cavitron % | 100 |
| | D50 [μm] | 2 |
| capsule | Pyraclostrobin, | 250 g |
| core | technical | |
| | Solvesso 200 ND | 250 g |
| | Emulsogen 3510 | 15 g |
| | Borresperse Na | 13 g |
| capsule | Lupranat M 20 S | 95 g |
| wall | HMDA | 37.50 g |
| aqueous | Xanthan gum | 1 g |
| phase | Acticide MBS | 2 g |
| | Silicon SRE | 2 g |
| | 1,2-Propylenglykol | 30 g |
| | Wasser dest. | ad 1 L |

B: Samples 6-10

| | | Sample Number |
|---|---|---|
| | | 2 |
| | Setting at Cavitron | 35 |
| | D50 [μm] | 9 |
| capsule | Pyraclostrobin, | 200 g |
| core | technical | |
| | Solvesso 200 ND | 200 g |
| | Plurafac LF 1300 | |
| | Emulsogen 3510 | 12 g |
| | Borresperse Na | 10.40 g |
| capsule | Lupranat M 20 S | 76 g |
| wall | HMDA | 30 g |
| dispersed | Plurafac LF 1300 | |
| adjuvant | Q 8 Puccini P 29 | |
| systems | Atlox 4912 | |
| | Emulsogen 3510 | |
| aqueous | Xanthan gum | 0.80 g |
| phase | Acticide MBS | 1.60 g |
| | Silicon SRE | 1.60 g |
| | Glycerin | |
| | 1,2-Propylenglykol | 24 g |
| | Plurafac LF 711 | 100 g |
| | Lutensol ON 60 | |
| | Wasser dest. | ad 1 L |

C: Samples 11-15

| | | Sample Number |
|---|---|---|
| | Setting at Cavitron | |
| | [%] | |
| | D50 [μm] | |
| capsule | Pyraclostrobin, | |
| core | technical | |
| | Solvesso 200 ND | |
| | Isobornylacetat | |
| | Emulsogen 3510 | |
| | Borresperse Na | |
| capsule | Lupranat M 20 S | |
| wall | HMDA | |
| aqueous | Xanthan gum | |
| phase | Acticide MBS | |
| | Silicon SRE | |
| | Glycerin | |
| | 1,2-Propylenglykol | |
| | Genapol C-100 | |
| | Lutensit A-BO | |
| | Tween 20 | |
| | Empilan KR 6 | |
| | Wasser dest. | |

D: Samples 16-21

| | | Sample Number |
|---|---|---|
| | | 3 |
| | 100 | 35 |
| | 3 | 9 |
| capsule | Pyraclostrobin, | 100 g |
| core | technical | |
| | Solvesso 200 ND | |
| | Isobornylacetat | 233.30 g |
| | Q 8 Puccini P 29 | |
| | Plurafac LF 1300 | |
| | Emulsogen 3510 | 10 g |
| | Tersperse 2500 | |
| | Mowiol 18-88 | |
| | Borresperse Na | 8.70 g |
| capsule | Lupranat M 20 S | 6.70 g |
| wall | Basonat HI 100 | |
| | DETA, 100% | |
| | HMDA | 8.30 g |
| | 10% aq. solution | |
| dispersed | Plurafac LF 1300 | |
| adjuvant | Q 8 Puccini P 29 | |
| systems | Atlox 4912 | |
| | Emulsogen 3510 | |
| aqueous | Xanthan gum | 1 g |
| phase | Acticide MBS | 2 g |
| | Silicon SRE | 2 g |
| | Glycerin | 50 g |
| | 1,2-Propylenglykol | |
| | Synergen gL 5 | 200 g |
| | Plurafac LF 900 | |
| | Wasser dest. | |

The suspension of PU capsules of Tables 1A-D) and Tables 2) were prepared using the concentration [g/l; referring to the concentration to the overall suspension] as summarized in Table I.

The composition of comparative example [Table 2, No. 1] is a composition in accordance with WO10/105,971.

The aqueous phase was prepared by dissolving Borresperse Na in water at ambient temperature. In a separate vessel a solution of pyraclostrobin in the solvent was prepared, if necessary under gentle heating up to 60° C. After the solution turned clear, it was cooled down to 20° C. and in case the capsule core contains and additional surfactant, this was added and dissolved next and finally the amount of isocyanate as given by the recipe.

This solution was then pre-emulsified by pouring the organic solution into the aqueous solution using a simple blade stirrer in a suitably large vessel. After stirring 5-15 seconds, the complete content is passed through a rotor-stator mill at a preset energy input level as % of 100% (Cavitron CD 1000) into a reaction vessel, which is equipped with a slow agitation stirrer, dropping funnel and heat-exchange jacket. After transfer is completed, the stirrer is started at 200 rpm and the diluted amine solution (typically 10% w/w) is added over a period of 15 minutes.

On completion of the amine addition, the heating is switched on and the temperature inside the encapsulation vessel is increased to 60° C. for 4 hours (depending on the recipe and the amount and type of isocyanate used therein). Eventually, a part of the antifoam is added, in case foaming occurs during the curing reaction.

After completion of the reaction, which can be monitored by following the fading isocyanate band in the IR spectrum, the mixture is cooled down and the finishing is done by adding anti-freeze, biocide, the residual amount of antifoam, viscosifier, the additional optional adjuvant and water to adjust the targeted active ingredient loading.

This finished capsule suspension of pyraclostrobin can be mixed further with suspension concentrates of other active ingredients, e.g. epoxiconazole or a surfactant/oil mixture can be emulsified into the capsule suspension or further surfactants can be incorporated.

The amount of non-encapsulated pyraclostrobin (“free pyraclostrobin”) was determined as follows:

A small sample of the formulation is being diluted in two steps. At first 1:100 dilution is done and the sample left standing at 22° C. undisturbed for 2 hours. Next, an aliquot of this sample is being diluted 1:5000 and left again standing for 2 hours at 22° C.
After the second standing time, the sample is centrifuged at 4000 rpm for 15 minutes and a probe of the clear supernatant is subject to HPLC analysis for free pyraclostrobin content.

TABLE 2

| | | Example |
|---|---|---|
| | | 1 [Comparative |
| | | Exampe] |
| | Setting at Cavitron [%] | 100 |
| | Measured free F500 [ppb] | 11 |
| | D50 [μm] | 2 |
| capsule | Pyraclostrobin, technical | 250.00 g |
| core | Solvesso 200 ND | 250.00 g |
| | Emulsogen 3510 | 15.00 g |
| capsule | Borresperse Na | 13.00 g |
| wall | Lupranat M 20 S | 95.00 g |
| | HMDA 10% aq. solution | 37.50 g |
| | Xanthan Gum | 1.00 g |
| | Acticide MBS | 2.00 g |
| | Silicon SRE-PFL | 2.00 g |
| | 1,2-Propylenglykol | 30.00 g |
| | Wasser dest. | ad 1 L |
| | | Example |
| | | 2 |
| | Setting at Cavitron [%] | 35 |
| | D50 [μm] | 9 |
| capsule | Pyraclostrobin, technical | 200.00 g |
| core | Solvesso 200 ND | 200.00 g |
| | Isobornylacetat | |
| | Emulsogen 3510 | 12.00 g |
| capsule | Borresperse Na | 10.40 g |
| wall | Lupranat M 20 S | 76.00 g |
| | HMDA 10% aq. solution | 30.00 g |
| | Xanthan Gum | 0.80 g |
| | Acticide MBS | 1.60 g |
| | Silicon SRE-PFL | 1.60 g |
| | Glycerin | |
| | 1,2-Propylenglykol | 24.00 g |
| | Plurafac LF 711 | 100.00 g |
| | Lutensol ON 60 | |
| | Genapol C-100 | |
| | Lutensit A-BO | |
| | Wasser dest. | ad 1 L |

| | | Example | | |
|---|---|---|---|---|
| | | 3 | 4 | 5 |
| | Setting at Cavitron [%] | 60 | 35 | 65 |
| | Measured free F500 [ppb] | 10 | | 9 |
| | D50 [μm] | 8 | 9 | 7 |
| capsule | Pyraclostrobin, technical | 100.00 g | 100.00 g | 100.00 g |
| core | Fluxapyroxad, technical | | | |
| | Solvesso 200 ND | 100 | 100 | 100 |
| | Isobornylacetat | | | |
| | Plurafac LF 1312 | 37.5 | 37.5 | 37.5 |
| | Plurafac LF 1300 | | | |
| | Emulsogen 3510 | 11.30 g | 11.30 g | 11.30 g |
| capsule | Borresperse Na | 9.80 g | 9.80 g | 9.80 g |
| wall | Lupranat M 20 S | | | |
| | Basonat HI 100 | 39.9 | 39.9 | 39.9 |
| | DETA, 100% | 10.9 | 10.9 | 10.9 |
| | HMDA 10% aq. solution | | | |
| | Xanthan Gum | 1.50 g | 1.50 g | 1.50 g |
| | Acticide MBS | 2.00 g | 2.00 g | 2.00 g |
| | Silicon SRE-PFL | 2.00 g | 2.00 g | 2.00 g |
| | Glycerin | 50.00 g | 50.00 g | 50.00 g |
| | Cittric acid | 1.00 g | 1.00 g | 1.00 g |
| | Plurafac LF 711 | | 100 | 50 |
| | Plurafac LF 900 | 100 | | |
| | Wasser dest. | ad 1 L | ad 1 L | ad 1 L |

| | | Example | | | |
|---|---|---|---|---|---|
| | | 6 | 7 | 8 | 9 |
| | Setting at Cavitron [%] | 65 | 65 | 100 | 60 |
| | Measured free F500 [ppb] | | | | 18 |
| | D50 [μm] | 7 | 7 | 2 | 7 |
| capsule | Pyraclostrobin, technical | 100.00 g | 100.00 g | | 100.00 g |
| core | Fluxapyroxad, technical | | | 67.00 g | |
| | Solvesso 200 ND | 100 | | | 100.00 g |
| | Isobornylacetat | | 205 | | |
| | Genagen 4296 | | | 300.00 g | |
| | Q 8 Puccini P 29 | | | | |
| | Plurafac LF 1312 | 37.5 | 37.5 | | 37.50 g |
| | Plurafac LF 1300 | | | 50.00 g | |
| | Emulsogen 3510 | 11.30 g | 11.30 g | 15.00 g | 11.30 g |
| | Tersperse 2500 | | | 30.00 g | |
| | Mowiol 18-88 | | | 8.00 g | |
| capsule | Borresperse Na | 9.80 g | 9.80 g | | |
| wall | Lupranat M 20 S | | | | |
| | Basonat HI 100 | 39.9 | 39.9 | 25.00 g | 39.9 |
| | DETA, 100% | 7.5 | 7.5 | 13.00 g | 10.9 |
| | Xanthan Gum | 1.50 g | 1.50 g | 1.00 g | 2.50 g |
| | Sipernat 22 | | | | 5.00 g |
| | Acticide MBS | 2.00 g | 2.00 g | 2.00 g | 2.00 g |
| | Silicon SRE-PFL | 2.00 g | 2.00 g | 2.00 g | 2.00 g |
| | Glycerin | 50.00 g | 50.00 g | | 50.00 g |
| | 1,2-Propylenglykol | | | 70.00 g | |
| | Cittric acid | 1.00 g | 1.00 g | | 1.00 g |
| | Plurafac LF 300 | | | | |
| | Plurafac LF 711 | | 100.00 g | | |
| | Plurafac LF 801 | | | | 100.00 g |
| | Plurafac LF 900 | 100 | | | |
| | Wasser dest. | ad 1 L | ad 1 L | ad 1 L | ad 1 L |
| | | Example | | | |
| | | 10 | 11 | 12 | 13 |
| | Setting at Cavitron [%] | 30 | 35 | 35 | 60 |
| | Measured free F500 | 4 | 8 | 11 | 10 |
| | [ppb] | | | | |
| | D50 [μm] | 10 | 9 | 9 | 8 |
| capsule | Pyraclostrobin, technical | 100.00 g | 100.00 g | 100.00 g | 100.00 g |
| core | Solvesso 200 ND | 100.00 g | 100.00 g | 100.00 g | |
| | Isobornylacetat | | | | 206.80 g |
| | Plurafac LF 1312 | 37.50 g | 37.50 g | 37.50 g | |
| | Plurafac LF 1300 | | | | 37.60 g |
| | Emulsogen 3510 | 11.30 g | 11.30 g | 11.30 g | 11.30 g |
| | Tersperse 2500 | | | | |
| | Mowiol 18-88 | | | | |
| capsule | Borresperse Na | 9.80 g | 9.80 g | 9.80 g | 9.80 g |
| wall | Lupranat M 20 S | | | | 71.40 g |
| | Basonat HI 100 | 39.90 g | 39.90 g | 39.90 g | |
| | DETA, 100% | 10.90 g | 10.90 g | 10.90 g | |
| | HMDA 10% aq. solution | | | | 28.00 g |
| | Xanthan Gum | 2.00 g | 2.00 g | 2.00 g | 2.00 g |
| | Acticide MBS | 2.00 g | 2.00 g | 2.00 g | 2.00 g |
| | Silicon SRE-PFL | 2.00 g | 2.00 g | 2.00 g | 2.00 g |
| | Glycerin | 50.00 g | 50.00 g | 50.00 g | 50.00 g |
| | 1,2-Propylenglykol | | | | |
| | Cittric acid | 1.00 g | 1.00 g | 1.00 g | 1.00 g |
| | Plurafac LF 300 | | | 50.00 g | |
| | Plurafac LF 801 | | 50.00 g | | |
| | Plurafac LF 900 | 50.00 g | | | 50.00 g |
| | Wasser dest. | ad 1 L | ad 1 L | ad 1 L | ad 1 L |

| | | Example | | |
|---|---|---|---|---|
| | | 14 | 15 | 16 |
| | Setting at Cavitron [%] | 30 | 30 | 35 |
| | Measured free F500 [ppb] | 10 | 14 | 19 |
| | D50 [μm] | 9 | 9 | 6 |
| capsule | Pyraclostrobin, technical | 100 | 100 | 100 |
| core | Solvesso 200 ND | | 100 | |
| | Isobornylacetat | 154.1 | | 154.1 |
| | Plurafac LF 1312 | 37.50 g | 37.50 | 113 |
| | Emulsogen 3510 | 11.30 g | 11.3 | 11.3 |
| capsule | Borresperse Na | 9.80 g | 9.80 | 9.8 |
| wall | Lupranat M 20 S | | | 71.4 |
| | Basonat HI 100 | 39.90 g | 39.90 | |
| | DETA, 100% | 10.90 g | 10.90 | |
| | HMDA, 100% | | | 2.8 |
| | Xanthan Gum | 2.00 g | 2.00 | 2.0 |
| | Acticide MBS | 2.00 g | 2.00 | 2.0 |
| | Silicon SRE-PFL | 2.00 g | 2.00 | 2.0 |
| | Glycerin | 50.00 g | 50.00 | 50.00 |
| | Cittric acid | 1.00 g | 1.00 | 1.0 |
| | Plurafac LF 900 | 50.00 g | 75.0 | |
| | Wasser dest. | ad 1 L | ad 1 L | ad 1 L |

### Example 2

Rice were seeded in the field in small plots with about 1 sqm each and 4 replications. At sign of first natural infection they were treated with the given rate of formulations as indicated in Table 1/2 in about 5001 Water/ha.

Additionally the plants were inoculated with an inoculum suspensions of spores of P. oryzae, which were produced by washing infected leaf material from older plants, after the first application. 3 applications with a 7 days interval were carried out. 21 days after first equivalent to 8 days after last application, the infection rate were assessed visually as percent damaged leaf area and based on that the efficacy according to Abbott were calculated.

The efficacy (E) using Abbot's formula is calculated as follows:

E=(1−α/β)·100

α corresponds to the fungal infection of the treated plants in % and
β corresponds to the fungal infection of the untreated (control) plants in %

An efficacy of 0 means that the infection level of the treated plants corresponds to that of the untreated control plants; an efficacy of 100 means that the treated plants were not infected.

It showed that the formulations according to the present invention showed much better activity than the prior art formulation from the Comparative Example (Table 2, No 1), despite that they had very similar release rate into the water in paddy condition.

TABLE 3

| | | | | | Amount of |
|---|---|---|---|---|---|
| | | Rate | | Efficacy | free |
| No | Sample No | (l/ha) | g ai/ha | (Abbott) | pyraclostrobin |
| 1 | No 1 Comparatvie | 0.40 | 100 | 37.6 | 11 |
| | Example | | | | |
| 2 | Table 2, No 10 | 1.00 | 100 | 75.5 | 3.4 |
| 3 | Table 2, No. 15 | 1.00 | 100 | 76.4 | 14 |
| 4 | Table 2, No. 3 | 1.00 | 100 | 79.7 | 10 |
| 5 | Table 2, No. 5 | 1.00 | 100 | 73.6 | 9 |
| 6 | Table 2, No. 11 | 1.00 | 100 | 86.7 | 8 |
| 7 | Table 2, No. 12 | 1.00 | 100 | 66.6 | 11 |
| 8 | Table 2, No. 9 | 1.00 | 100 | 91.4 | 18 |
| 9 | Table 2, No. 13 | 1.00 | 100 | 83.9 | 10 |
| 10 | Table 2, No. 16 | 1.00 | 100 | 70.1 | 19 |
| 11 | Table 2, No. 14 | 1.00 | 100 | 78.5 | 9 |

1-15. (canceled)

16. Microcapsules wherein
(i) the capsule has a core-shell structure; and
(ii) at least 80% of the pesticide is dissolved in an organic solvent at 25° C. in the core; and
(iii) the capsule shell is based on a polyurethane comprising polyfunctional isocyanate and a polyamine in polymerized form; and
(iv) the ratio by weight of capsule shell in relation to the weight of the capsule is from 1-20%-by weight

17. The microcapsules according to claim 16, wherein average particle size of the capsules is from 0.5 to 8 μm.

18. The microcapsules according to claim 16, wherein the solvent comprises at least on non-polar solvent.

19. The microcapsules according to claim 16, additionally comprising a surfactant in the core.

20. The microcapsules according to claim 16, wherein at least one encapsulated pesticide is selected from the groups of strobilurine fungicides or carboxamide fungicides.

21. The microcapsules according to claim 20, wherein the strobilurine is pyraclostrobin.

22. The microcapsules according to claim 20, wherein the encapsulated carboxamide fungicide is fluxapyroxad.

23. The microcapsules according to claim 20, wherein the encapsulated fungicide is a mixture of fluxapyroxad and pyraclostrobin.

24. A formulation comprising microcapsules as defined in claim 16 and additional formulation auxiliaries.

25. The formulation as defined in claim 24 further comprising an additional non-encapsulated pesticide.

26. The formulation as defined in claim 25, wherein the encapsulated pesticide is pyraclostrobin and the additional non-encapsulated pesticide is selected from bixafen, fluxapyroxad, isopyrazam, penflufen, penthiopyrad, sedaxane, tricyclazole, isoprothiolane, carpropamid, epoxiconazole, prothioconazole, difenoconazole, propiconazole, isotianil, kasugamycin, carpropamid, probenazole and diclocymet.

27. A method of combating phytopathogenic pests in a paddy rice field, comprising treating the paddy rice field with a formulation according to claim 24.

28. A method of increasing the health of rice plants in a paddy rice field, comprising treating the paddy rice field with a formulation according to claim 24.

29. The method according to claim 27, wherein the pest are phytophathogenic fungi.

30. The method according to claim 27, wherein the pest are phytophathogenic insects.

31. The method according to claim 27, wherein the average particle size of the capsules is from 0.5 to 8 μm.

32. The method according to claim 27, wherein the solvent in the core shell of the microcapsules comprises at least on non-polar solvent.

33. The method according to claim 27, the microcapsules additionally comprise a surfactant in the core.

34. The method according to claim 27, wherein at least one encapsulated pesticide is a strobilurin or a carboxamide fungicide.

35. The method according to claim 34, wherein the strobilurin is pyraclostrobin.
